(19) United States
(12) Patent Application Publication
(10) Pub. No.: US 2010/0088948 A1
(43) Pub. Date: Apr. 15, 2010

(54) Device for catching phototaxis flying insects

(75) Inventor: Shih Tsai Yeh, Changhua (TW)

Correspondence Address: BACON & THOMAS, PLLC, 625 SLATERS LANE, FOURTH FLOOR, ALEXANDRIA, VA, 22314-1176, US

(73) Assignees: Taichung District Agricultural Research And Extension Station,; Council Of Agriculture Executive Yuan, Tatsuen Township (TW)

(21) Appl. No.: 12/285,863

(22) Filed: Oct. 15, 2008

(51) Int. Cl. A01M 1/04; A01M 1/14

(52) U.S. Cl. 43/113; 43/114

(57) ABSTRACT

The invention is to provide a device for catching phototaxis flying insects, which is utilized by light irradiating to attract the phototaxis flying insects to gather into the device for facilitating catching the phototaxis flying insects, comprises a light reflecting member having a plurality of reflecting portions for reflecting multi-directional diffused light for attracting the phototaxis flying insects; and a catching member for allowing the phototaxis flying insects to be caught and collected.

### FIELD OF THE INVENTION

This invention relates to the field of a device for catching insects, and, more particularly, to a device for catching phototaxis flying insects which attracts phototaxis flying insects such as, millers, moths and so on, and catches them with a catching member.

### DESCRIPTION OF THE PRIOR ART

For exterminating flying insects such as millers, moths and so on, there are harmful to plants or crops, for example Casuarina tussuck moth which host plants involve 103 family, 424 species spreading out farmlands to threaten economical corps growth, it will reduce the harvest of the corps, and therefore damages economical effect seriously. It is effective to attract the flying insects by means of a lamp by making use of phototaxis of the flying insects and to catch the attracted flying insects with a catching member. Such devices comprise the lamp for attracting flying insects.

A device for catching the flying insects 12 shown in FIG. 1, it shows that a basin 10 faces phototaxis flying insects for reflecting uni-directional reflection light 11 for attracting phototaxis flying insects in a single specified orientation, and catching phototaxis flying insects. The basin 10 has an opening for liquid filled into, such as water, medicament solution, pheromone solution. When the phototaxis flying insects are attracted by the reflection light 11, these will fly forward into water, medicament solution, pheromone solution or adhesive material on the basin 10 to be caught. Accordingly, based-on the uni-directional reflection light of the prior art, attracting area for catching phototaxis flying insects is narrow such that catching amount of the phototaxis flying insects is limited.

A device for detecting the flying insects is provided with a lamp for attracting the flying insects, a base on which the lamp for attracting the flying insects is provided, a clear casing attached on the lower side of the base, whose cross section view is approximately semicircular, a sheet for catching the flying insects located below the lamp, and an opening for invasion of the flying insects formed on the bottom of the casing.

However, in the former device for detecting the flying insects, because the opening for invasion is only provided in a bottom of a casing and other parts of the casing are blockaded, it has the disadvantage that the attracting efficiency is low because an area through which the flying insects invade is limited.

Against this disadvantage, in order to enlarge the total area of the radiated light, the present invention provides a new design for catching the phototaxis flying insects or birds to overcome the aforementioned problem.

### SUMMARY OF THE INVENTION

The object of this invention is to provide a device for catching phototaxis flying insects to increase an attracting rate of the phototaxis flying insects by enlarging the diffusion area of reflection light out of a case from the lamp for catching phototaxis flying insects.

Accordingly, a device for catching phototaxis flying insects according to this invention, which is utilized by light irradiating to attract the phototaxis flying insects to gather into the device for facilitating catching the phototaxis flying insects, comprises a light reflecting member having a plurality of reflecting portions facing the phototaxis flying insects for reflecting multi-directional diffused light for attracting the phototaxis flying insects; and a catching member for allowing the phototaxis flying insects to be caught and collected.

Furthermore, the plurality of reflection portions include a plurality of multi-directional concave-convex portions. In the device, the catching member is a case with an opening for accumulating liquid to allow the phototaxis flying insects to fly into thereof to be caught. Moreover, the device further comprises an adhesive member for attaching the phototaxis flying insects. The light reflecting member is disposed at internal of said catching member, for example disposed at the upper portion, the bottom portion and the side portion of the catching member. The light reflecting member is a type of solid geometry or paillette attached. The light reflecting member includes buckled reflecting plate, gathering light reflection beads, or buckled gathering paillette, or others diffused-light created materials. The device further comprises buckled color adhesive plate attached on the outer or inner surface of the catching member. The device further comprises a self-diffused member attached on the outer or inner surface of the catching member. The light reflecting member comprises covering buckled PE light reflection cloth, surrounding farmland buckled PE silver light reflection nets, buckled light reflection belting, buckled light reflection disc, buckled light reflection balloon, buckled light reflection roulette, buckled light reflection fan blade. The device further comprises a plurality of small size mirrors, paillettes, adhesive papers or light reflection film attached on the outer or inner surface of the catching member. The device further comprises one or more pieces diffused member with specified shape and pattern attached on the outer or inner surface of the catching member.

### BRIEF DESCRIPTION OF THE DRAWINGS

Further objections and advantages of the invention can be more fully understood from the following detailed description taken in conjunction with the accompanying drawings in which:

FIG. 1 is a cross section view illustrating a device for catching phototaxis flying insects according to the prior art;

FIG. 2 is a cross section view illustrating a device for catching phototaxis flying insects according to the present invention;

FIG. 3 is a perspective view illustrating a catching member of the device according to the present invention;

FIG. 4 is a view illustrating the buckled tinfoil paper;

FIG. 5 is a diagrammatic view of comparison diagram of caught mounts of the phototaxis flying insects by using four trapping devices according to the present invention;

FIG. 6 is a diagrammatic view of comparison diagram of caught mounts of the phototaxis flying insects by using four trapping devices according to the present invention.

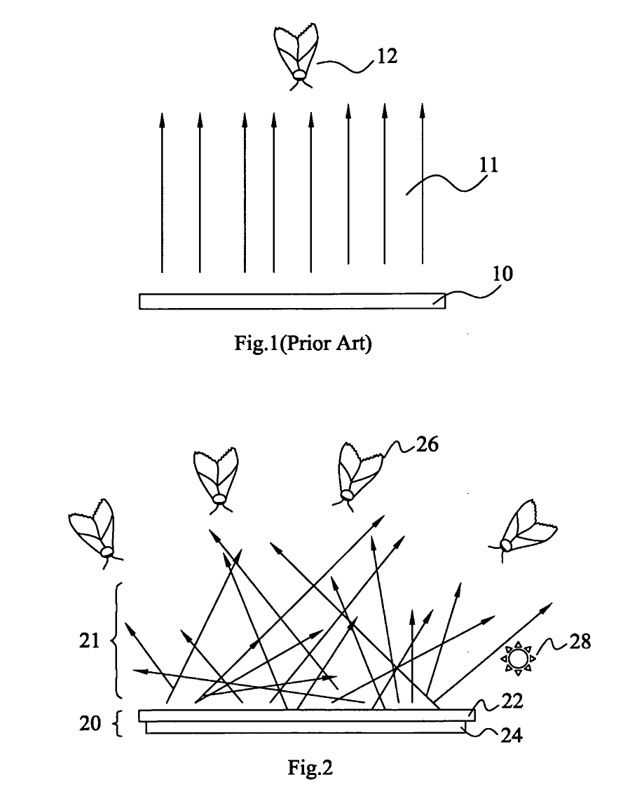

### DESCRIPTION OF THE PREFERRED EMBODIMENT

The invention will now be described in greater detail with preferred embodiments of the invention and illustrations attached. Nevertheless, it should be recognized that the preferred embodiments of the invention is only for illustrating. Besides the preferred embodiment mentioned here, present invention can be practiced in a wide range of other embodiments besides those explicitly described, and the scope of the present invention is expressly not limited expect as specified in the accompanying Claims.

The device for catching the phototaxis flying insects or bird gathers of the present invention can be applied on the farmland phototaxis flying insect for monitoring and preventing the phototaxis flying insects or birds.

The preferred embodiment according to the present invention is explained by referring to the drawings as follows.

The preferred embodiment of a device for catching phototaxis flying insects 26 is shown in FIG. 2. The device 20 may be constituted of a catching member 24 and a light reflecting member 22. The light reflecting member 22 has a plurality of reflecting portions facing phototaxis flying insects for reflecting multi-directional diffused light for attracting and catching phototaxis flying insects. The catching member 24, for example a case or a container, is for allowing the phototaxis flying insects flying forward to the case attracted by the reflected light to be caught and collected.

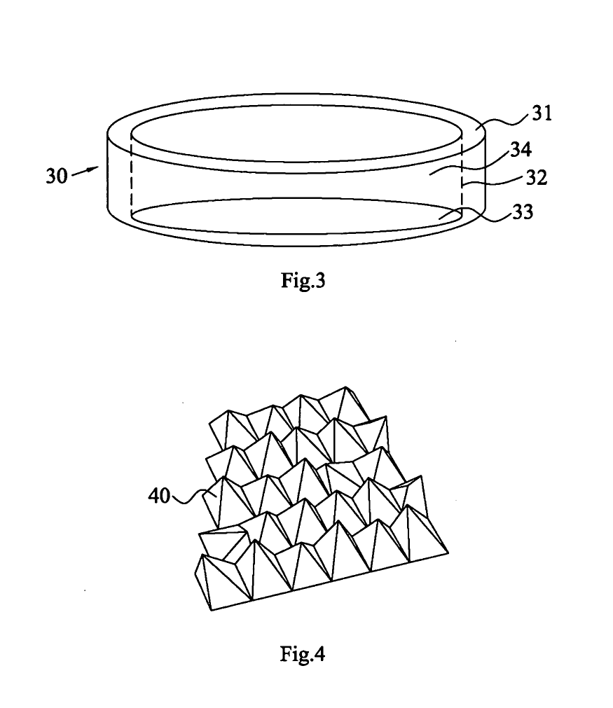

In one embodiment, the catching member 30, for example a case or a container, has an opening 34 for accumulating liquid to allow the phototaxis flying insects to fly into thereof to reach the purpose of catching, shown in FIG. 3. The liquid includes, for example, water, medicament solution, pheromone solution, or others attracted materials for the phototaxis flying insects. When the phototaxis flying insects are attracted by the reflection light 21, these will fly forward into water, medicament solution, pheromone solution or others attracted materials for the phototaxis flying insects to be caught. The case 30 has an upper portion 31 extending in a horizontal direction, a bottom portion 33 extending in parallel with the upper portion and a side portion 32 between the upper portion 31 and the bottom portion 33 for connecting to light reflecting member respectively, for reflecting irradiated light to reach the multi-directional diffused light. Thus, because the total area of the diffused light with multi-directional becomes larger than that of the prior art so that radiation area of light becomes great, the attracting efficiency and the effect for catching phototaxis flying insects may be increased.

In one embodiment, an adhesive member may be disposed at the bottom portion 33 of the catching member 30 for attaching the phototaxis flying insects which are flying into the case. The adhesive member is applied or stuck on the bottom surface of the case 30 for collecting phototaxis flying insects such as Lepidoptera (includes Plutella xylostella (Diamond-back moth), Sphingidae, Geometridae, Noctuidae), Gypsy moth, Lymantria xylina Swinhoe (Casuarina tussuck moth), moths and so on, which can be caught by the adhesive member. The light reflecting member is disposed at the upper portion 31, the bottom portion 33 and the side portion 32 which locate at internal of the catching member 30. The light reflecting member has a plurality of reflecting portions, for example a plurality of multi-directional concave-convex portions facing body of the phototaxis flying insects. In one embodiment, multi-directional concave-convex portions are disposed at internal of the catching member 30 such that multi-directional concave-convex portions diffuses light as light illuminated for reflecting multi-directional diffused light 21 for attracting the phototaxis flying insects in multi-directional flying. Therefore, utilizing liquid, for example including water, medicament, pheromone, or others attracted materials, accumulated in the opening 34 of the case 30 on the multi-directional concave-convex portions, the phototaxis flying insects in multi-directional flying will fly forward into the liquid by the multi-directional diffused light to reach the purpose of catching.

In one embodiment, a light source (lamp) 28 is preferably positioned adjacent to the light reflecting member 22 for attracting the phototaxis flying insects. The lamp 28 may be a well-known fluorescent light which radiates light in a ultra-violet area where an effect of attracting phototaxis flying insects arises. In one embodiment, a light source (lamp) 28 may be positioned or embedded into the device, for example catching insect lamp, which is utilized by the lamp for attracting flying insects and outer high voltage electric shock nets such that the phototaxis flying insects is burned as connected to the electric shock nets, based-on nocturnal phototaxis of the flying insects for catching the phototaxis flying insects. In other words, the device of the present invention may be a catching insect lamp.

In one embodiment, the light reflecting member 22 may be attached on the surface of the catching member 24, or embedded into the catching member 24 for reflecting irradiated light. For example, the light reflecting member 22 may be a type of solid geometry or paillette attached, such as buckled CD (compact disc), buckled reflecting plate, gathering light reflection beads, or buckled gathering paillette, or others diffused-light created materials to further enlarge the diffusion area.

In one embodiment, an adhesive member, a color member or various shape pieces, for example buckled yellow, white, blue, green, silver or orange adhesive plate, may be attached on the outer or inner surface of the catching member 24 for attracting the phototaxis flying insects or bird gathers, and further catching these.

In one embodiment, a self-diffused member, for example fluorescent buckled yellow, white, blue, green, silver or orange adhesive plate, may be attached on the outer or inner surface of the catching member 24 for diffusing light, or fluorescent lamp adding buckled member disposed into the catching member 24 for diffusing light out from inner of the catching member 24.

The device of the present invention can catch phototaxis flying insects or bird gathers, wherein the device is covering on the ground, concealing in the air or surrounding between the farmland. For example, the light reflecting member of the device comprises covering buckled PE light reflection cloth, surrounding farmland buckled PE silver light reflection nets, buckled light reflection belting, buckled light reflection disc, buckled light reflection balloon, buckled light reflection roulette, buckled light reflection fan blade, and so on, for reflecting multi-directional diffused light to reach the purpose of enhancing the efficiency of catching phototaxis flying insects or bird gathers.

In one embodiment, a plurality of small size mirrors, paillettes, adhesive papers or light reflection film, may be attached on the outer or inner surface of the catching member 24 for diffusing light as light irradiated for attracting the phototaxis flying insects or birds to further enlarge the diffusion area.

In one embodiment, one or more pieces diffused member with specified shape and pattern may be attached on the outer or inner surface of the catching member 24 for diffusing light as light irradiated for attracting the phototaxis flying insects or birds to further enlarge the diffusion area.

Furthermore, openings of the catching member 24 for allowing the flying insects to invade are formed to be as large as possible in the bottom portions of the catching member 24 to increase the catching amount of the phototaxis flying insects in a specified period.

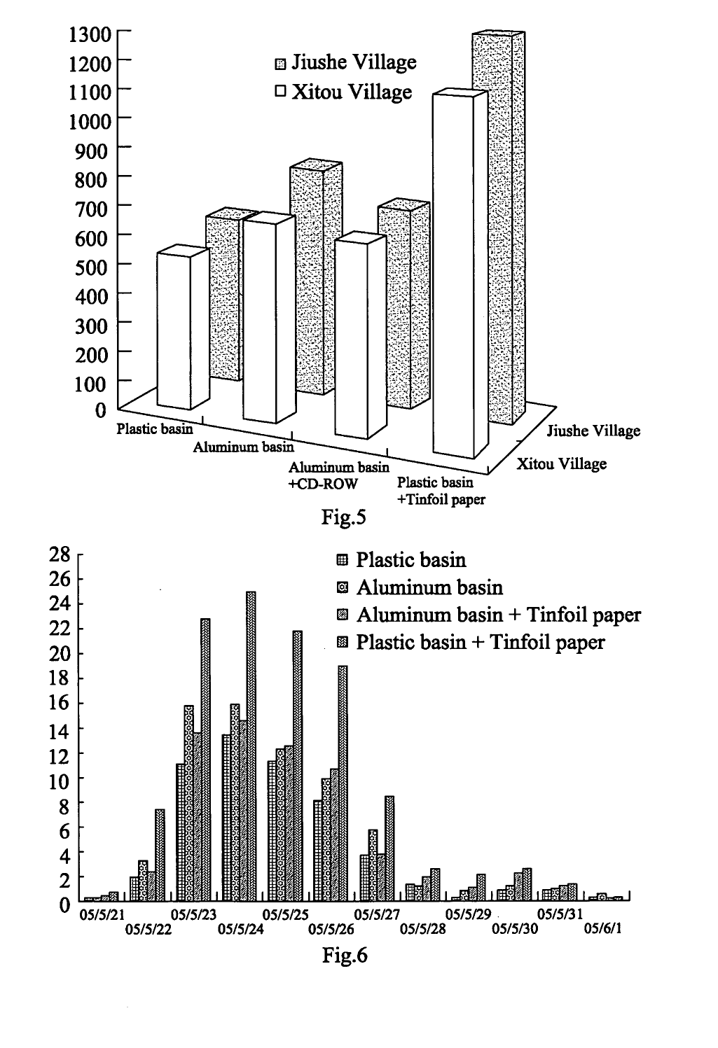

Referring to the FIG. 5, it depicts total caught mounts of the phototaxis flying insects, for example Lymantria xylina adult, by using four trapping devices on lamplight at two villages (Xitou Village, Jiushe Village) in a specified period. In the FIG. 6, it shows the caught mounts of the phototaxis flying insects, for example Lymantria xylina adult, by using four trapping devices on lamplight at the Fenyuan city Xitou village in a different date. The above mentioned four trapping devices include plastics basin, aluminum basin, aluminum basin adding CD-ROW, and plastics basin adding tinfoil paper, respectively. Apparently, plastics basin adding tinfoil paper has far attracted mounts of the phototaxis flying insects than that of the formers, almost 2.0 times. This is because the tinfoil paper may create a plurality of concave-convex portions 40 by buckling, shown in FIG. 4, for reflecting multi-directional diffused light facing phototaxis flying insects body, and it create larger reflecting area than that of the prior art such that the attracting efficiency and the effect for catching phototaxis flying insects is about 2.0 times of the formers. Thus, according to the above constitution, the device for catching phototaxis flying insects of the present invention has an un-expected result than that of the prior arts.

Moreover, according to the present invention, the total area of the reflection light can be enlarged, so that an attracting rate of the phototaxis flying insects can be further increased.

The advantages of the present inventions are:

The device of the present is simple for forming, easy to monitor, low manufacturing cost, better attracting efficiency and catching effect, wider catching range, and can combine with others catching methods or devices.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A device for catching phototaxis flying insects, which is utilized by light irradiating to attract said phototaxis flying insects for facilitating catching said phototaxis flying insects, comprising:
a light reflecting member having a plurality of reflection portions facing said phototaxis flying insects for reflecting multi-directional diffused light for attracting said phototaxis flying insects; and
a catching member for allowing said phototaxis flying insects to be caught and collected.

2. The device of claim 1, wherein said plurality of reflecting portions includes a plurality of multi-directional concave-convex portions.

3. The device of claim 1, wherein said catching member is a case with an opening for accumulating liquid to allow said phototaxis flying insects to be caught.

4. The device of claim 1, further comprising an adhesive member for attaching said phototaxis flying insects.

5. The device of claim 1, wherein said light reflecting member is disposed at internal of said catching member.

6. The device of claim 1, wherein said light reflecting member is disposed at the upper portion, the bottom portion and the side portion of said catching member.

7. The device of claim 1, wherein said light reflecting member is a type of solid geometry or paillette attached.

8. The device of claim 1, wherein said light reflecting member includes buckled reflecting plate, gathering light reflection beads, or buckled gathering paillette, or others diffused-light created materials.

9. The device of claim 1, further comprising buckled color adhesive plate attached on the outer or inner surface of said catching member.

10. The device of claim 1, further comprising a self-diffused member attached on the outer or inner surface of said catching member.

11. The device of claim 1, wherein said light reflecting member comprises covering buckled PE light reflection cloth, surrounding farmland buckled PE silver light reflection nets, buckled light reflection belting, buckled light reflection disc, buckled light reflection balloon, buckled light reflection roulette, buckled light reflection fan blade.

12. The device of claim 1, further comprising a plurality of small size mirrors, paillettes, adhesive papers or light reflection film attached on the outer or inner surface of said catching member.

13. The device of claim 1, further comprising one or more pieces diffused member with specified shape and pattern attached on the outer or inner surface of said catching member.

14. The device of claim 1, wherein said device is a catching insect lamp.
